(19) United States
(12) Patent Application Publication
(10) Pub. No.: US 2024/0364156 A1
(43) Pub. Date: Oct. 31, 2024

(54) ROTOR AND MOTOR

(71) Applicant: NIDEC CORPORATION, Kyoto (JP)

(72) Inventors: Ta-Yin LUO, Taipei City (TW); Yu-Wei HSU, Taipei City (TW); Kuan YANG, Taipei City (TW); Pei-Chun SHIH, Taipei City (TW); Sheng-Chan YEN, Taipei City (TW); Guo-Jhih YAN, Taipei City (TW); Cheng-Tsung LIU, Kaohsiung (TW)

(21) Appl. No.: 18/646,767

(22) Filed: Apr. 26, 2024

(30) Foreign Application Priority Data
Apr. 27, 2023 (JP) 2023-073432

(51) Int. Cl. H02K 1/276

(52) U.S. Cl. CPC H02K 1/2773

(57) ABSTRACT

One aspect of a rotor of the present disclosure is a rotor that includes a rotor core extending along the axial direction and a plurality of auxiliary magnets disposed in the rotor core. The rotor core includes a slit group including a plurality of first slits aligned in a radial direction, and a second slit disposed radially inside the slit group when viewed from the axial direction. The first slit extends along the circumferential direction in a shape protruding radially inward when viewed from the axial direction. The second slit includes a magnet housing portion extending along the radial direction, and a pair of outer flux barrier portions. The auxiliary magnet is disposed in the magnet housing portion with the circumferential direction as the magnetization direction.

### CROSS REFERENCE TO RELATED APPLICATIONS

The present invention claims priority under 35 U.S.C. § 119 to Japanese Patent Application No. 2023-073432 filed on Apr. 27, 2023, the entire content of which is incorporated herein by reference.

### FIELD OF THE INVENTION

The present disclosure relates to a rotor and a motor.

### BACKGROUND

A rotary electric machine in which a permanent magnet is arranged in a flux barrier, in order to improve torque of a reluctance motor, is known. For example, conventionally, in addition to arranging a permanent magnet in a flux barrier, an example is known in which a permanent magnet having a larger total magnetic flux amount is arranged on the radially outer side to improve torque.

The magnetic flux passes through the shortest reluctance path inside the rotor core. For this reason, in the inner rotor type motor, when the rotor is multipolarized to six or more poles, the magnetic path in the rotor core is likely to be formed unevenly in the radially outer region. Therefore, the utilization factor of the region on the radially inner side in the rotor core decreases, and the output torque of the motor cannot be sufficiently improved in some cases. Also in the conventional rotor, a region on the radially outer side mainly contributes to torque generation, and a region on the inner side from the flux barrier cannot be effectively used.

### SUMMARY

One aspect of an exemplary rotor of the present disclosure is a rotor that is rotatable about a central axis as a rotation axis, and includes a rotor core extending along the axial direction and a plurality of auxiliary magnets disposed in the rotor core. The rotor core includes a slit group including a plurality of first slits aligned in a radial direction, and a second slit disposed radially inside the slit group when viewed from the axial direction. The slit groups and the second slits are arranged in the circumferential direction respectively. The first slit extends along the circumferential direction in a shape protruding radially inward when viewed from the axial direction. The second slit includes a magnet housing portion extending along the radial direction, and a pair of outer flux barrier portions extending from a radially outer end of the magnet housing portion to one side and the other side in the circumferential direction. The auxiliary magnet is disposed in the magnet housing portion with the circumferential direction as the magnetization direction.

One aspect of an exemplary motor of the present disclosure includes the above-described rotor and a stator that surrounds the rotor from radially outside.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic cross-sectional view of a motor according to an embodiment;

FIG. 2 is a cross-sectional view of a rotor of an embodiment taken along line II-II of FIG. 1;

FIG. 3 is a partial cross-sectional view illustrating a part of an embodiment;

FIG. 4 is a diagram illustrating a simulation result of a flow of a magnetic flux in a motor;

FIG. 5 is a partial cross-sectional view illustrating a part of a rotor according to Modification 1;

FIG. 6 is a partial cross-sectional view illustrating a part of a rotor according to Modification 2;

FIG. 7 is a partial cross-sectional view illustrating a part of a rotor according to Modification 3;

FIG. 8 is a partial cross-sectional view illustrating a part of a rotor according to Modification 4; and

FIG. 9 is a partial cross-sectional view illustrating a part of a rotor according to Modification 5.

### DETAILED DESCRIPTION

A Z-axis direction appropriately illustrated in each drawing is a vertical direction in which a positive side is an “upper side” and a negative side is a “lower side”. A central axis J appropriately illustrated in each drawing is a virtual line that is parallel to the Z-axis direction and extends in the vertical direction. In the following description, an axial direction of a central axis J, that is, a direction parallel to the vertical direction, is simply referred to as an “axial direction”, a radial direction around the central axis J is simply referred to as a “radial direction”, and a circumferential direction around the central axis J is simply referred to as a “circumferential direction”.

The vertical direction, the upper side, and the lower side are merely terms for describing a relative positional relationship between the respective units, and an actual layout relationship and the like may be other than the layout relationship represented by these terms.

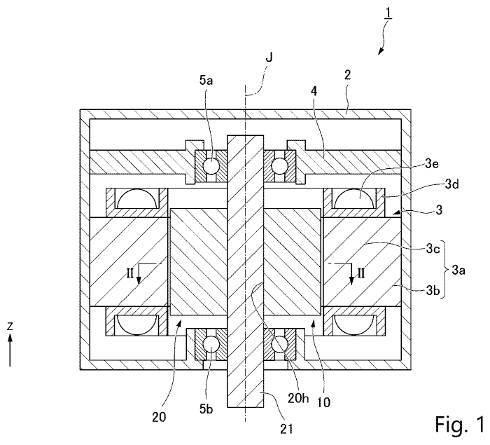

FIG. 1 is a schematic cross-sectional view of a motor according to an embodiment.

A motor 1 of the present embodiment is an inner-rotor motor. The motor 1 of the present embodiment is a permanent magnet auxiliary type synchronous reluctance motor (PMa-SynRM).

The motor 1 includes a housing 2, a rotor 10, a stator 3, a bearing holder 4, and bearings 5a and 5b. The housing 2 accommodates therein the rotor 10, the stator 3, the bearing holder 4, and the bearings 5a and 5b. The bottom part of the housing 2 holds the bearing 5b. The bearing holder 4 holds the bearing 5a. Each of the bearings 5a and 5b is, for example, a ball bearing.

The stator 3 surrounds the rotor 10 from radially outside. The stator 3 includes a stator core 3a, an insulator 3d, and a plurality of coils 3e. The stator core 3a includes a core back 3b and a plurality of teeth 3c. The core back 3b has an annular shape centered on the central axis J. The plurality of teeth 3c extend radially inward from the core back 3b. Although not illustrated, the plurality of teeth 3c are disposed at equal intervals over the entire circumference along the circumferential direction. The plurality of coils 3e are attached to the stator core 3a via the insulator 3d.

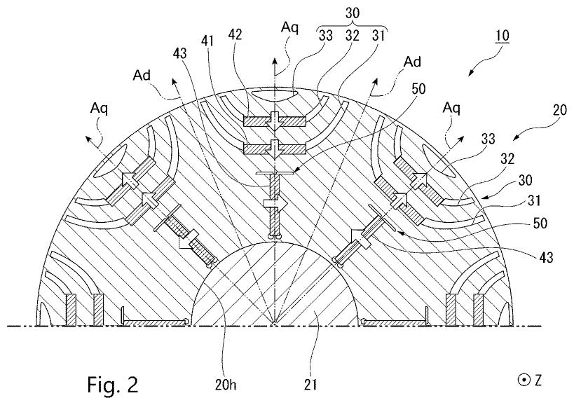

FIG. 2 is a cross-sectional view of the rotor 10 taken along line II-II in FIG. 1.

The rotor 10 includes a shaft 21, a rotor core 20, and a plurality of main magnets 41 and 42 and a plurality of auxiliary magnets 43 arranged in the rotor core 20. The rotor 10 is rotatable about the central axis J as a rotation axis.

As illustrated in FIG. 1, the shaft 21 extends in the axial direction along the central axis J. The shaft 21 has a columnar shape centered on the central axis J. The shaft 21 is supported by the bearings 5a and 5b to be rotatable about the central axis J. The material of the shaft 21 is not particularly limited, but an iron-based alloy is adopted from the viewpoint of rigidity and manufacturing cost.

The rotor core 20 is made of a magnetic material. The rotor core 20 extends along the axial direction. The rotor core 20 is fixed to the outer peripheral surface of the shaft 21. The rotor core 20 has a central hole 20h axially penetrating the rotor core 20. As illustrated in FIG. 2, the central hole 20h has a circular shape centered on the central axis J when viewed from the axial direction. The shaft 21 passes through the central hole 20h. The shaft 21 is fixed in the central hole 20h by press fitting, for example. Although not illustrated, the rotor core 20 is configured of, for example, a plurality of electromagnetic steel plates laminated in the axial direction.

FIG. 2 virtually illustrates a q-axis Aq and a d-axis Ad of the rotor 10. The direction in which the d-axis Ad extends (hereinafter, d-axis Ad direction) is a radial direction passing through the circumferential center of the magnetic pole of the rotor 10. The direction in which the q-axis Aq extends (hereinafter, q-axis Aq direction) is a radial direction passing through the circumferential center between magnetic poles adjacent to each other in the circumferential direction. The rotor 10 has magnetic anisotropy in the q-axis Aq direction and the d-axis Ad direction.

The rotor core 20 includes a plurality of first slits 31, 32, and 33 and a plurality of second slits 50. Each of the first slits 31, 32, and 22 and the second slits 50 penetrates the rotor core 20 in the axial direction.

The plurality of first slits 31, 32, and 33 include three types of slits arranged along the radial direction. In the following description, when the three types of first slits 31, 32, and 33 are distinguished, one located on the radially innermost side is referred to as an innermost slit 31, one located on the radially outermost side is referred to as an outermost slit 33, and one located between the innermost slit 31 and the outermost slit 33 is referred to as an intermediate slit 32. The innermost slit 31, the intermediate slit 32, and the outermost slit 33 are arranged in this order from the radially inner side to the radially outer side.

One innermost slit 31, one intermediate slit 32, and one outermost slit 33 constitute one slit group 30. That is, the rotor core 20 has the slit group 30 including the plurality of first slits 31, 32, and 33 arranged in the radial direction. The rotor core 20 has a plurality of slit groups 30 arranged at equal intervals along the circumferential direction. That is, in each slit group 30, the plurality of first slits 31, 32, and 33 are arranged on the q-axis Aq. In each slit group 30, the plurality of first slits 31, 32, and 33 have a line-symmetric shape with respect to the q-axis Aq.

The rotor core 20 of the present embodiment has eight slit groups 30 arranged in the circumferential direction. However, the number of the slit groups 30 is not limited to this embodiment as long as it is an even number. In the present embodiment, the case where the slit group 30 includes the three first slits 31, 32, and 33 has been described, but the number of first slits included in the slit group 30 is not limited to the present embodiment as long as the number is plural.

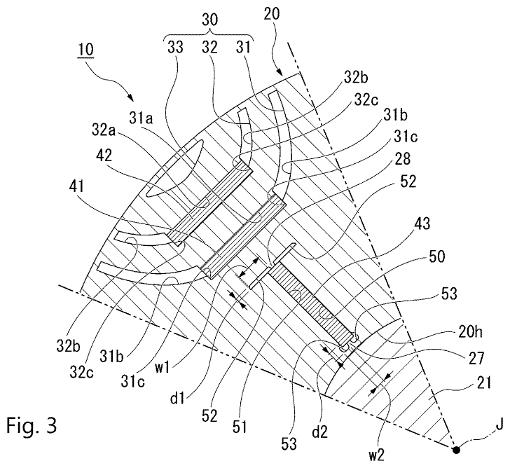

FIG. 3 is a partial cross-sectional view illustrating a part of the rotor 10.

As illustrated in FIG. 3, each of the first slits 31, 32, and 33 extends along the circumferential direction in a shape protruding inward in the radial direction when viewed from the axial direction. The outermost slit 33 has a substantially triangular shape that protrudes radially inward when viewed from the axial direction. The intermediate slit 32 is located to be separated radially inward of the outermost slit 33. Both circumferential ends of the intermediate slit 32 are located on both circumferential sides of the outermost slit 33. The innermost slit 31 is located to be separated radially inward of the intermediate slit 32. Both ends of the innermost slit 31 are located on both circumferential sides of the intermediate slit 32. In the present embodiment, the outermost slit 33, the intermediate slit 32, and the innermost slit 31 are arranged side by side at substantially equal intervals in the radial direction. In the present embodiment, the entire outermost slit 33, both circumferential ends of the intermediate slit 32, and both circumferential ends of the innermost slit 31 are located at the radially outer edge of the rotor core 20. The entire outermost slit 33, both circumferential ends of the intermediate slit 32, and both circumferential ends of the innermost slit 31 are located slightly radially inward from the outer peripheral surface of the rotor core 20, for example.

The innermost slit 31 includes a main magnet housing portion 31a and a pair of flux barrier portions 31b. The main magnet housing portion 31a has a rectangular shape whose longitudinal direction is a direction orthogonal to the radial direction when viewed from the axial direction. A main magnet 41 to be described later is housed in the main magnet housing portion 31a. Each of the pair of flux barrier portions 31b is connected to either end in the circumferential direction of the main magnet housing portion 31a. One of the pair of flux barrier portions 31b located on one circumferential side extends in a direction toward the radially outer side as it goes to the one circumferential side. The other of the pair of flux barrier portions 31b located on the other circumferential side extends in a direction toward the radially outer side as it goes to the other circumferential side. Each of the pair of flux barrier portions 31b has an arc shape protruding radially inward when viewed from the axial direction. The arc centers of the pair of flux barrier portions 31b of one innermost slit 31 coincide with each other. In the present embodiment, the arc center of the flux barrier portion 31b is located on the q-axis Aq (see FIG. 2) on the radially outer side of the innermost slit 31.

Similarly, the intermediate slit 32 includes a main magnet housing portion 32a and a pair of flux barrier portions 32b. The main magnet housing portion 32a has a rectangular shape whose longitudinal direction is a direction orthogonal to the radial direction when viewed from the axial direction. The main magnet housing portion 32a of the intermediate slit 32 has substantially the same shape as the main magnet housing portion 31a of the innermost slit 31. A main magnet 42 to be described later is housed in the main magnet housing portion 32a. Each of the pair of flux barrier portions 32b is connected to either end in the circumferential direction of the main magnet housing portion 32a. One of the pair of flux barrier portions 32b located on one circumferential side extends in a direction toward the radially outer side as it goes to the one circumferential side. The other of the pair of flux barrier portions 32b located on the other circumferential side extends in a direction toward the radially outer side as it goes to the other circumferential side. Each of the pair of flux barrier portions 32b has an arc shape protruding radially inward when viewed from the axial direction. The arc centers of the pair of flux barrier portions 32b of one intermediate slit 32 coincide with each other. In the present embodiment, the arc center of the flux barrier portion 32b is located on the q-axis Aq (see FIG. 2) on the radially outer side of the intermediate slit 32. The arc centers of the pair of flux barrier portions 32b of the intermediate slit 32 coincide with the arc centers of the pair of flux barrier portions 31b of the innermost slit 31 disposed on the radially inner side.

As illustrated in FIG. 2, the plurality of second slits 50 are aligned in the circumferential direction. The second slit 50 is disposed radially inside the slit group 30 when viewed from the axial direction. The plurality of second slits 50 are located radially inside the different slit groups 30. The number of the second slits 50 matches the number of the slit groups. The rotor core 20 of the present embodiment is provided with eight second slits 50. That is, the plurality of slit groups 30 and the plurality of second slits 50 are aligned in the circumferential direction respectively. The plurality of second slits 50 are arranged at equal intervals in the circumferential direction. The second slit 50 is disposed on the q-axis Aq. The second slit 50 has a line-symmetric shape with respect to the q-axis Aq.

As illustrated in FIG. 3, the second slit 50 includes a magnet housing portion 51, a pair of outer flux barrier portions 52, and a pair of inner flux barrier portions 53. The magnet housing portion 51 has a rectangular shape whose longitudinal direction is the radial direction when viewed from the axial direction. That is, the magnet housing portion 51 extends along the radial direction. An auxiliary magnet 43 to be described later is housed in the magnet housing portion 51.

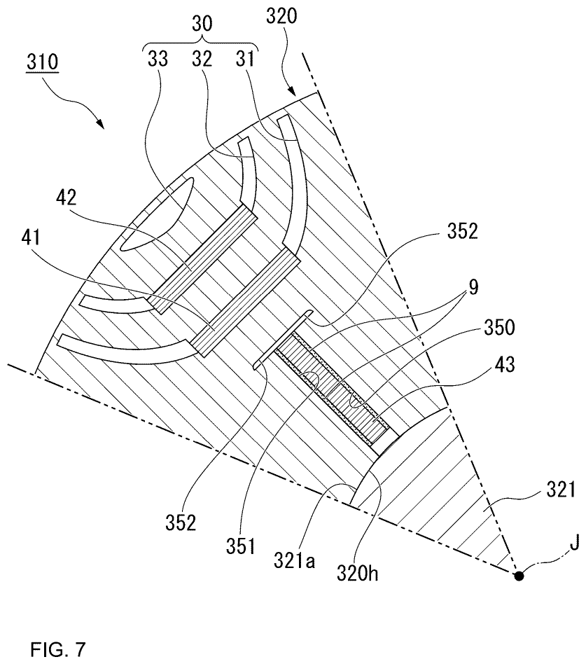

The pair of outer flux barrier portions 52 is connected to the radially outer end of the magnet housing portion 51. The outer flux barrier portions 52 extend from the radially outer end of the magnet housing portion 51 to one side and the other side in the circumferential direction, respectively. The outer flux barrier portions 52 of the present embodiment extend linearly in a direction orthogonal to the q-axis Aq (see FIG. 2). A first protrusion 28 is provided between the pair of outer flux barrier portions 52. The pair of outer flux barrier portions 52 is defined by the first protrusion 28. The first protrusion 28 protrudes radially inward from a surface facing radially inward among the inner surfaces of the second slit 50. The tip of the first protrusion 28 is in contact with an auxiliary magnet 43. As a result, the first protrusion 28 restricts the radially outward movement of the auxiliary magnet 43. When the auxiliary magnet 43 is bonded and fixed to the rotor core 20, the first protrusion 28 is omitted. In this case, the pair of outer flux barrier portions 52 are connected to each other (FIG. 7 and elsewhere).

The pair of inner flux barrier portions 53 is connected to the radially inner end of the magnet housing portion 51. The inner flux barrier portions 53 extend from the radially inner end of the magnet housing portion 51 to one side and the other side in the circumferential direction, respectively. A second protrusion 27 is provided between the pair of inner flux barrier portions 53. The pair of inner flux barrier portions 53 is defined by the second protrusion 27. The second protrusion 27 protrudes radially outward from a surface facing radially outward among the inner surfaces of the second slit 50. The tip of the second protrusion 27 is in contact with the auxiliary magnet 43. As a result, the second protrusion 27 restricts the radially inward movement of the auxiliary magnet 43. When the auxiliary magnet 43 is bonded and fixed to the rotor core 20, the second protrusion 27 is omitted. In this case, the pair of inner flux barrier portions 53 are connected to each other.

The main magnets 41 and 42 include a first main magnet 41 and a second main magnet 42. The rotor of the present embodiment includes eight pieces of the first main magnets 41 and eight pieces of the second main magnets 42. As the main magnets 41 and 42, for example, a ferrite magnet is employed.

The first main magnet 41 and the second main magnet 42 of the present embodiment have the same shape. The first main magnet 41 and the second main magnet 42 have a prismatic shape extending along the axial direction. The first main magnet 41 and the second main magnet 42 have a rectangular shape whose longitudinal direction is a direction orthogonal to the radial direction when viewed from the axial direction.

The first main magnet 41 and the second main magnet 42 may have different shapes. As an example, the length dimension along the circumferential direction of the first main magnet 41 may be larger than the length dimension along the circumferential direction of the second main magnet 42.

Further, in the present embodiment, the case where the main magnets 41 and 42 are arranged only in the two first slits 31 and 32, among the three first slits 31, 32 and 33 constituting the slit group 30, has been described. However, the main magnets may be disposed in all the first slits 31, 32, and 33, or the main magnet may be disposed only in any one of the first slits 31, 32, and 33. That is, the main magnet may be disposed in at least one first slit in each slit group 30.

The first main magnet 41 is disposed in the main magnet housing portion 31a of the innermost slit 31. The second main magnet 42 is disposed in the main magnet housing portion 32a of the intermediate slit 32. Therefore, the first main magnet 41 and the second main magnet 42 are arranged side by side in the radial direction. The first main magnet 41 and the second main magnet 42 are disposed on the q-axis Aq. The first main magnet 41 is disposed radially inside the second main magnet 42. The first main magnet 41 of the present embodiment is provided over substantially the entire main magnet housing portion 31a in the axial direction. Similarly, the second main magnet 42 is provided over substantially the entire main magnet housing portion 32a in the axial direction.

In FIG. 2, the magnetization directions of the main magnets 41 and 42 and the auxiliary magnet 43 are indicated by arrows. As illustrated in FIG. 2, the first main magnet 41 and the second main magnet 42 are magnetized in the radial direction. The magnetization direction of the first main magnet 41 and the magnetization direction of the second main magnet 42 accommodated in the same slit group 30 coincide with each other. That is, the N poles of the first main magnet 41 and the second main magnet 42 arranged side by side in the radial direction both face radially outward or both face radially inward.

The magnetization directions of the main magnets 41 and 42 arranged in the slit groups 30 adjacent to each other in the circumferential direction are reversed in the radial direction. Therefore, the first main magnet 41 having the N-pole directed radially outward and the first main magnet 41 having the N-pole directed radially inward are alternately arranged along the circumferential direction. Similarly, the second main magnet 42 having the N-pole directed radially outward and the second main magnet 42 having the N-pole directed radially inward are alternately arranged along the circumferential direction.

As illustrated in FIG. 3, a surface of the first main magnet 41 facing radially outward is opposed to and preferably in contact with a surface of the main magnet housing portion 31a facing radially inward. The surface of the first main magnet 41 facing radially inward is opposed to and preferably in contact with the surface of the main magnet housing portion 31a facing radially outward. A radially outer region of both circumferential end surfaces of the first main magnet 41 is in contact with a step surface 31c provided at a boundary portion between the main magnet housing portion 31a and the flux barrier portion 31b. Accordingly, the first main magnet 41 is positioned in the circumferential direction inside the innermost slit 31. A radially outer region of both circumferential end surfaces of the first main magnet 41 is exposed in the flux barrier portion 31b. The flux barrier portion 31b is a void portion. The flux barrier portion 31b suppresses leakage of a magnetic flux from the circumferential end surface of the first main magnet 41.

The surface facing radially outward of the second main magnet 42 faces and preferably contacts the surface facing radially inward of the main magnet housing portion 32a. The surface facing radially inward of the second main magnet 42 is opposed to and preferably in contact with the surface facing radially outward of the main magnet housing portion 32a. A radially inner region of both circumferential end surfaces of the second main magnet 42 is in contact with a step surface 32c provided at a boundary portion between the main magnet housing portion 32a and the flux barrier portion 32b. As a result, the second main magnet 42 is positioned in the circumferential direction inside the intermediate slit 32. A radially outer region of both circumferential end surfaces of the second main magnet 42 is exposed in the flux barrier portion 32b. The flux barrier portion 32b is a void portion. The flux barrier portion 32b suppresses leakage of a magnetic flux from the circumferential end surface of the second main magnet 42.

The auxiliary magnet 43 has a prismatic shape extending along the axial direction. The auxiliary magnet 43 has a rectangular shape whose longitudinal direction is the radial direction when viewed from the axial direction. The auxiliary magnet 43 is disposed in the magnet housing portion 51 of the second slit 50. The auxiliary magnet 43 is disposed on the q-axis Aq. The auxiliary magnet 43 of the present embodiment is provided over substantially the entire axial direction of the magnet housing portion 51.

As illustrated in FIG. 2, the auxiliary magnet 43 is magnetized in the circumferential direction. The magnetization directions of the auxiliary magnets 43 arranged in the second slits 50 adjacent to each other in the circumferential direction are reversed in the circumferential direction. Therefore, the auxiliary magnet 43 having the N-pole directed to one side in the circumferential direction and the auxiliary magnet 43 having the N-pole directed to the other side in the circumferential direction are alternately arranged along the circumferential direction.

As illustrated in FIG. 3, the surface of the auxiliary magnet 43 facing one side in the circumferential direction is opposed to and preferably in contact with the surface of the magnet housing portion 51 facing the other side in the circumferential direction. The surface of the auxiliary magnet 43 facing the other circumferential direction is opposed to and preferably in contact with the surface of the magnet housing portion 51 facing one circumferential direction. The circumferential central portion of the surface facing radially outward of the auxiliary magnet 43 contacts the first protrusion 28. The circumferential central portion of the surface facing radially inward of the auxiliary magnet 43 is in contact with the second protrusion 27. As a result, the auxiliary magnet 43 is positioned in the radial direction inside the second slit 50.

Both circumferential ends of the surface facing radially outward of the auxiliary magnet 43 are exposed to the outer flux barrier portion 52. Similarly, both circumferential ends of the surface facing radially inward of the auxiliary magnet 43 are exposed to the inner flux barrier portion 53. The outer flux barrier portion 52 and the inner flux barrier portion 53 suppress leakage of a magnetic flux from radially inner and outer end surfaces of the auxiliary magnet 43, respectively.

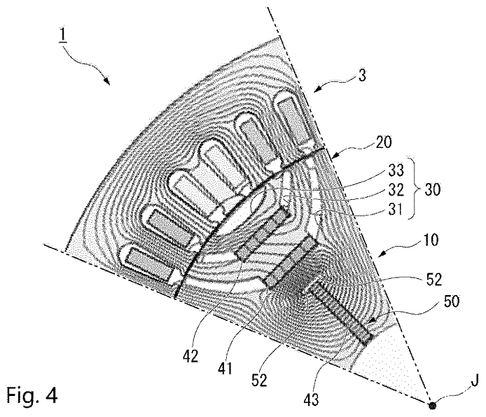

FIG. 4 is a diagram illustrating a simulation result of a flow of a magnetic flux in the motor 1 having a configuration similar to that of the present embodiment.

In general, when the number of poles of the rotor 10 increases, the distance between adjacent magnetic poles decreases, and accordingly, the magnetic path formed between the magnetic poles tends to concentrate in a region on the radially outer side of the rotor core 20. On the other hand, according to the present embodiment, by providing the auxiliary magnet 43 on the radially inner side of the slit group 30, the magnetic flux is induced in the radially inner region of the rotor core 20, and the magnetic flux density in each of the radially inner and outer regions of the rotor core 20 can be made uniform. By uniformly distributing the magnetic flux density in the radially inner and outer regions in the rotor core 20, it is possible to further increase the magnetic flux density in the d-axis Ad direction, and to further increase the output torque of the motor 1. According to the rotor 10 of the present embodiment, since the magnetic flux density in the d-axis Ad direction is increased, the positions in the d-axis Ad direction and the q-axis Aq direction can be easily determined, and the rotation control of the rotor 10 becomes easy.

Such an effect is more remarkably obtained in the rotor 10 having the number of poles of 6 or more. That is, as shown in the present embodiment, when the rotor 10 has six or more slit groups 30, it is possible to obtain an advantage of the multipolarization of the rotor 10 while suppressing the concentration of magnetic paths in the rotor core 20 due to the multipolarization. As an advantage of making the rotor 10 multipolar, it is possible to suppress vibration when the rotor 10 rotates, and it is possible to obtain the motor 1 having excellent quietness and high efficiency.

Further, the rotor 10 of the present embodiment includes the outer flux barrier portions 52 extending to both sides in the circumferential direction from the radially outer end surface of the auxiliary magnet 43. The outer flux barrier portion 52 extends in the circumferential direction along the first slit 31 of the slit group 30 on the radially inner side of the slit group 30. Therefore, the outer flux barrier portion 52 can regulate the flow of the magnetic flux in the d-axis Ad direction between the slit group 30 and the auxiliary magnet 43. As a result, the magnetic flux density in the d-axis Ad direction can be further increased, and the output torque of the motor 1 can be increased. In addition, the outer flux barrier portion 52 prevents the magnetic flux of the auxiliary magnet 43 from being short-circuited on the radially outer side of the auxiliary magnet 43. According to the rotor 10 of the present embodiment, the torque of the rotor 10 can be suitably increased by increasing the magnetic path that passes through the auxiliary magnet 43 and is guided in the d-axis Ad direction.

As illustrated in FIG. 3, in the outer flux barrier portion 52 of the present embodiment, the circumferential dimension w1 is larger than the radial dimension d1 (w1>d1). By ensuring the long circumferential dimension w1 of the outer flux barrier portion 52, it is possible to guide the magnetic flux in the d-axis Ad direction in a wide region in the circumferential direction between the slit group 30 and the outer flux barrier portion 52, and to allow the magnetic flux to be easily concentrated in the d-axis Ad direction. On the other hand, by reducing the radial dimension d1 of the outer flux barrier portion 52, it is possible to secure a wide region between the slit group 30 and the outer flux barrier portion 52 in the radial direction, and to easily guide the magnetic flux in the d-axis Ad direction. According to the present embodiment, by increasing the circumferential dimension w1 of the outer flux barrier portion 52 and decreasing the radial dimension d1, it is possible to allow the magnetic flux to be effectively concentrated in the d-axis Ad direction.

The rotor 10 of the present embodiment includes the inner flux barrier portion 53 extending from the radially inner end surface of the auxiliary magnet 43 to both sides in the circumferential direction. The inner flux barrier portion 53 prevents the magnetic flux of the auxiliary magnet 43 from being short-circuited on the radially inner side of the auxiliary magnet 43. According to the rotor 10 of the present embodiment, the torque of the rotor 10 can be suitably increased by increasing the magnetic path that passes through the auxiliary magnet 43 and is guided in the d-axis direction Ad.

In the inner flux barrier portion 53 of the present embodiment, the circumferential dimension w2 and the radial dimension d2 are substantially equal. According to the rotor core 20 of the present embodiment, it is possible to suppress a decrease in rigidity of the rotor core 20 in the vicinity of the radially inner end of the auxiliary magnet 43 due to the inner flux barrier portion 53. The circumferential dimension w1 of the outer flux barrier portion 52 in the present embodiment is larger than the circumferential dimension w2 of the inner flux barrier portion 53 (w1>w2). According to the present embodiment, it is possible to smooth the flow of the magnetic flux in the d-axis Ad direction on the radially outer side of the auxiliary magnet 43 while securing the rigidity of the rotor core 20 on the radially inner side of the auxiliary magnet 43.

In the present embodiment, the auxiliary magnet 43 is preferably a rare earth sintered magnet such as a neodymium magnet. The simulation result of the flow of the magnetic flux is illustrated in FIG. 4. In this example, the auxiliary magnet of the rotor to be simulated is a neodymium magnet, and the main magnet is a ferrite magnet. As the neodymium magnet, for example, a neodymium magnet having a composition represented by Nd—Fe—B is employed. By adopting a rare earth sintered magnet as the auxiliary magnet 43, it is possible to increase the magnetic force of the auxiliary magnet 43, and to further improve the output torque of the motor 1. However, the auxiliary magnet 43 may be another magnet such as a ferrite magnet. When a ferrite magnet is adopted as the auxiliary magnet 43, the improvement of the output torque of the motor 1 is limited, but the manufacturing cost of the motor 1 can be suppressed. Furthermore, in consideration of the balance between the output torque improvement and the manufacturing cost, another rare earth magnet such as a neodymium magnet containing dysprosium (Dy) or a samarium cobalt magnet (SmCo magnet), or still another type of magnet may be selected as the auxiliary magnet 43.

A rotor 10 of a modification that can be employed in the motor 1 of the above-described embodiment will be described. In the description of each modification described below, the same reference numerals are given to the same components as those of the embodiment or modification described above, and the description thereof will be omitted.

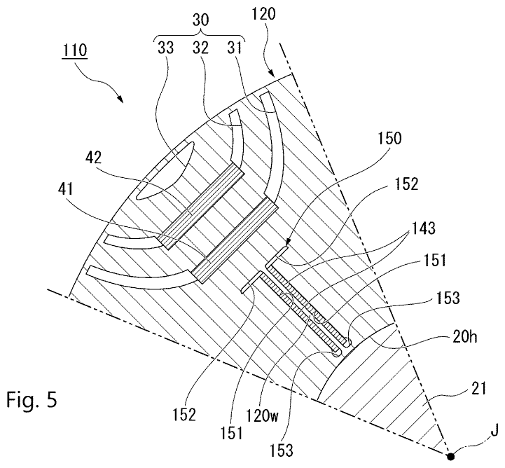

FIG. 5 is a partial cross-sectional view illustrating a part of a rotor 110 of Modification 1. The rotor 110 of the present modification is different from the above-described embodiment in that a plurality of auxiliary magnets 143 are arranged in one second slit 150.

Similarly to the above-described embodiment, the rotor 110 includes a shaft 21, a rotor core 120, a plurality of main magnets 41 and 42, and a plurality of auxiliary magnets 143. The rotor core 120 includes a plurality of slit groups 30 and a plurality of second slits 150. The second slit 150 of the present modification includes a plurality of magnet housing portions 151, a pair of outer flux barrier portions 152, and a pair of inner flux barrier portions 153.

In the present modification, two magnet housing portions 151 are provided in one second slit 150. The plurality of magnet housing portions 151 are aligned in the circumferential direction. Each of the magnet housing portions 151 extends along the radial direction. A wall portion 120w that partitions the magnet housing portions 151 is provided between the magnet housing portions 151 aligned in the circumferential direction. The wall portion 120w extends along the radial direction. The auxiliary magnet 143 is housed in each of the plurality of magnet housing portions 151. Therefore, two auxiliary magnets 143 are disposed in one second slit 150 of the present modification. The magnetization directions of the plurality of auxiliary magnets 143 arranged in one second slit 150 coincide with each other. That is, the N poles of the plurality of auxiliary magnets 143 housed in one second slit 150 both face one circumferential direction side or both face the other circumferential direction side.

The pair of outer flux barrier portions 152 extends from different magnet housing portions 151 to one side and the other side in the circumferential direction. Similarly, the pair of inner flux barrier portions 153 extends from different magnet housing portions 151 to one side and the other side in the circumferential direction.

The second slit 150 of the present modification includes a plurality of magnet housing portions 151 aligned in the circumferential direction and each housing the auxiliary magnet 143. According to the present modification, the magnetic force of the auxiliary magnet 143 disposed in the second slit 150 can be increased, and the magnetic flux can be suitably concentrated in the d-axis Ad direction on the radially inner side of the slit group 30. In addition, the plurality of auxiliary magnets 143 arranged in one second slit 150 of the present modification are in contact with the wall portion 120w disposed between the auxiliary magnets 143. Therefore, the magnetic flux can smoothly flow between the auxiliary magnets 143 along the circumferential direction, and the effect of distributing the magnetic flux in the radially inner region of the rotor core 120 can be enhanced.

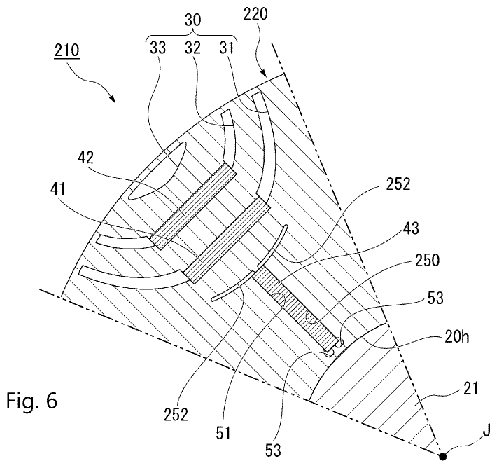

FIG. 6 is a partial cross-sectional view illustrating a part of a rotor 210 of Modification 2. The rotor 210 of the present modification differs from the above-described embodiment in the shape of an outer flux barrier portion 252.

Similarly to the above-described embodiment, the rotor 210 includes a shaft 21, a rotor core 220, a plurality of main magnets 41 and 42, and a plurality of auxiliary magnets 43. The rotor core 220 includes a plurality of slit groups 30 and a plurality of second slits 250. The second slit 250 includes a magnet housing portion 51, a pair of outer flux barrier portions 252, and a pair of inner flux barrier portions 53. The auxiliary magnet 43 is housed in the magnet housing portion 51.

The pair of outer flux barrier portions 252 is connected to the radially outer end of the magnet housing portion 51. The outer flux barrier portions 252 extend from the radially outer end of the magnet housing portion 51 to one side and the other side in the circumferential direction, respectively. The outer flux barrier portion 252 has an arc shape protruding radially inward when viewed from the axial direction. The arc centers of the pair of outer flux barrier portions 252 of one second slit 250 coincide with each other. The arc center of the outer flux barrier portion 252 is located radially outside the second slit 250.

The outer flux barrier portion 252 of the present modification extends along the circumferential direction in a shape protruding radially inward when viewed from the axial direction. Therefore, the outer flux barrier portion 252 of the present modification extends radially outward with increasing distance from the magnet housing portion 51 in the circumferential direction. According to the present modification, the magnetic flux can be suitably guided in the d-axis Ad direction in the region between the slit group 30 and the outer flux barrier portion 252, and the magnetic flux density in the d-axis Ad direction can be increased.

FIG. 7 is a partial cross-sectional view illustrating a part of a rotor 310 of Modification 3. The rotor 310 of the present modification differs from the above-described embodiment in the configuration functioning as an inner flux barrier.

Similarly to the above-described embodiment, the rotor 310 includes a shaft 321, a rotor core 320, a plurality of main magnets 41 and 42, and a plurality of auxiliary magnets 43. The rotor core 320 includes a plurality of slit groups 30 and a plurality of second slits 350. The second slit 350 includes a magnet housing portion 351 and a pair of outer flux barrier portions 352.

In the present modification, the shaft 321 is made of a paramagnetic material such as an aluminum alloy.

Alternatively, as the shaft 321, a member having a configuration in which at least a part or the whole of the outer peripheral surface of a member made of an iron-based alloy is covered with a paramagnetic material such as an aluminum alloy can also be adopted. Furthermore, the shaft 321 may be made of an iron-based alloy, and at least a part or the whole of the inner peripheral surface of a central hole 320h of the rotor 310 may be covered with a paramagnetic material such as an aluminum alloy. When at least a part of the shaft 321 is made of an iron-based material, rigidity or strength of the shaft can be enhanced. In addition, the magnet housing portion 351 extends along the radial direction with a constant width dimension, and opens in the central hole 320h located radially inside the second slit 350. The opening of the magnet housing portion 351 is covered by an outer peripheral surface 321a of the shaft 321. When a part of the surface of the shaft 321 or a part of the inner peripheral surface of the central hole 320h is covered with a paramagnetic material such as an aluminum alloy, it is particularly preferable that the radially inner side of the second slit 350 covers a portion opened to the central hole 320h. Further, a part or all of the radially inner region of the second slit 350 may be filled with the paramagnetic material by a method such as casting. The auxiliary magnet 43 is housed in the magnet housing portion 351. An adhesive layer 9 is disposed between the auxiliary magnet 43 and the inner side surfaces of the magnet housing portion 351 facing one side and the other side in the circumferential direction. The adhesive layer 9 adhesively fixes the auxiliary magnet 43 to the inner side surface of the magnet housing portion 351. The pair of outer flux barrier portions 352 is connected to the radially outer end of the magnet housing portion 351. In the present modification, since the auxiliary magnet 43 of the present modification is bonded and fixed to the inner surface of the magnet housing portion 351, no protrusion is provided between the pair of outer flux barrier portions 352. Therefore, the pair of outer flux barrier portions 352 of this modification are connected to each other.

In the rotor 310 of the present modification, the second slit 350 is connected to the central hole 320h at the radially inner end. The surface facing radially inward of the auxiliary magnet 43 faces the outer peripheral surface 321a of the shaft 321 via the opening of the magnet housing portion 351. In the present modification, since the paramagnetic material is interposed in at least a part of the portion where the shaft 321 is in contact with the inner peripheral surface of the central hole 320h, a magnetic path is hardly formed inside the shaft 321. According to the present modification, it is possible to prevent the magnetic flux from leaking from the radially inner end surface of the auxiliary magnet 43 through the inside of the shaft 321 and short-circuiting. According to the present modification, it is possible to adopt a manufacturing process of inserting the auxiliary magnet 43 from the radially inner opening of the magnet housing portion 351. Further, according to the present modification, since the inner flux barrier portion is not provided in the second slit 350, the auxiliary magnet 43 can be disposed close to the outer peripheral surface 321a of the shaft 321. As a result, it is possible to downsize the entire rotor 310 in the radial direction, which leads to downsizing of the motor 1.

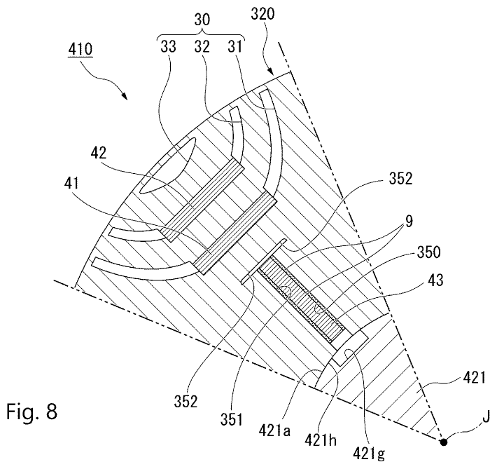

FIG. 8 is a partial cross-sectional view illustrating a part of a rotor 410 of Modification 4. The rotor 410 of the present modification differs from the above-described embodiment in the configuration functioning as an inner flux barrier.

Similarly to the above-described embodiment, the rotor 410 includes a shaft 421, a rotor core 420, a plurality of main magnets 41 and 42, and a plurality of auxiliary magnets 43. The rotor core 320 includes a plurality of slit groups 30 and a plurality of second slits 350. The second slit 350 includes a magnet housing portion 351 and a pair of outer flux barrier portions 352.

Similarly to Modification 3, the magnet housing portion 351 extends along the radial direction with a constant width dimension, and opens to a central hole 421h located radially inside the second slit 350. The auxiliary magnet 43 is housed in the magnet housing portion 351 and bonded and fixed via the adhesive layer 9. The material of the shaft 421 of the present modification is not particularly limited, but an iron-based alloy is adopted from the viewpoint of rigidity and manufacturing cost. An outer peripheral surface 421a of the shaft 421 has a recessed groove 421g. The recessed groove 421g faces the radially inner end of the second slit 350 and extends in the axial direction. Therefore, the second slit 350 and the recessed groove 421g are connected to each other.

In the rotor 410 of the present modification, the second slit 350 communicates with the recessed groove 421g provided in the outer peripheral surface 421a of the shaft 421 at the radially inner end. According to the present modification, the flux barrier portion is disposed inside the shaft 421, and it is possible to prevent the magnetic flux from leaking from the radially inner end surface of the auxiliary magnet 43 through the inside of the shaft 421 to cause a short circuit. According to the present modification, it is not necessary to select a paramagnetic material as a material constituting the shaft 421, and a low-cost material such as an iron-based alloy can be selected. Further, according to the present modification, since the inner flux barrier portion is not provided in the second slit 350, the auxiliary magnet 43 can be disposed close to the outer peripheral surface 421a of the shaft 421. As a result, it is possible to downsize the entire rotor 410 in the radial direction, which leads to downsizing of the motor 1.

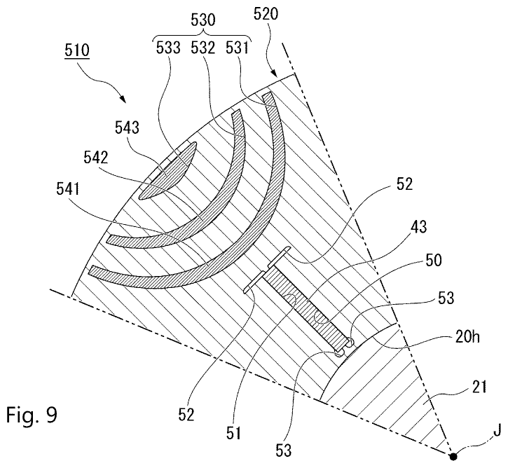

FIG. 9 is a partial cross-sectional view illustrating a part of a rotor 510 of Modification 5. The rotor 510 of the present modification is different from the above-described embodiment in that conductors 541, 542, and 543 are arranged in the first slits 531, 532, and 533.

Similarly to the above-described embodiment, the rotor 510 includes a shaft 21, a rotor core 520, a plurality of conductors 541, 542, and 543, and a plurality of auxiliary magnets 43. The rotor core 520 includes a plurality of slit groups 530 and a plurality of second slits 50. The slit group 530 includes three first slits 531, 532, and 533 aligned in the radial direction. Similarly to the above-described embodiment, the three first slits 531, 532, and 533 are referred to as an innermost slit 531, an intermediate slit 532, and an outermost slit 533, respectively.

The first slits 531, 532, and 533 extend along the circumferential direction in a shape protruding radially inward when viewed from the axial direction. The outermost slit 533 has a substantially triangular shape that protrudes radially inward when viewed from the axial direction. Each of the innermost slit 531 and the intermediate slit 532 has an arc shape protruding inward in the radial direction when viewed from the axial direction. The conductors 541, 542, and 543 are disposed in the first slits 531, 532, and 533, respectively. That is, the plurality of conductors 541, 542, and 543 are disposed in the rotor core 520. The plurality of conductors 541, 542, and 543 may be disposed in at least one of the first slit 531, 532, and 533 in each slit group 530.

When the conductors 541, 542, and 543 are disposed in the slit group 530 of the synchronous reluctance motor, the conductors are disposed in the rotating magnetic field. Therefore, when the magnetic field generated by the stator 3 rotates, an induced current flows through the conductors 541, 542, and 543 by electromagnetic induction, and a rotational force can be generated in the rotor 510 by the Lorentz force of the induced current. In particular, since the torque due to the Lorentz force can be obtained when the rotation of the stationary rotor 510 is started, the allowable inertial load at the time of starting the motor 1 can be improved. As described above, the synchronous reluctance motor with improved characteristics at the time of startup is also particularly called Direct-On-Line Synchronous Reluctance Motor (DOL SynRM). That is, according to the present modification, it is possible to provide the motor 1 with improved characteristics at the time of startup. Note that also in each of the above-described modifications, a configuration in which the conductors 541, 542, and 543 are arranged inside the slit group 30 may be adopted.

Although the embodiment of the present disclosure and the modifications thereof have been described above, the respective configurations and combinations thereof in the embodiment and the modifications are merely examples, and therefore addition, omission, substitution and other variations of the configurations can be made within the scope not departing from the gist of the present invention. Further, the present disclosure is not to be limited by the embodiment and the modifications thereof.

The application of the motor to which the present disclosure is applied is not particularly limited. The motor may be mounted on, for example, a vehicle or a device other than the vehicle. In addition, each configuration of the slit group in the above-described embodiment and the modifications thereof, for example, the shape, the number, and the like of the first slits are an example, and can be appropriately changed according to desired performance.

Note that the present technique can have the following configurations.

(1) A rotor rotatable about a central axis as a rotation axis, the rotor including: a rotor core extending along an axial direction; and a plurality of auxiliary magnets disposed in the rotor core, in which the rotor core includes: a slit group including a plurality of first slits aligned in a radial direction; and a second slit disposed on a radially inner side of the slit group when viewed from the axial direction, a plurality of the slit groups and a plurality of the second slits are respectively aligned in a circumferential direction, each of the plurality of first slits extends along the circumferential direction in a shape protruding radially inward when viewed from the axial direction, the second slit includes: a magnet housing portion extending along the radial direction; and a pair of outer flux barrier portions extending from a radially outer end of the magnet housing portion to one side and another side in the circumferential direction, and each of the auxiliary magnets is disposed in the magnet housing portion with the circumferential direction as a magnetization direction.

(2) The rotor according to (1), in which the second slit includes a pair of inner flux barrier portions extending from a radially inner end of the magnet housing portion to the one side and the other side in the circumferential direction.

(3) The rotor according to (1), further including a shaft extending in the axial direction along the central axis, in which the rotor core has a central hole through which the shaft passes, the second slit is connected to the central hole at a radially inner end, and at least a part of an outer peripheral surface of the shaft or at least a part of an inner peripheral surface of the central hole is made of a paramagnetic material.

(4) The rotor according to (1), further including a shaft extending in the axial direction with the central axis as a center, in which the rotor core has a central hole through which the shaft passes, the second slit is connected to the central hole at a radially inner end, and an outer peripheral surface of the shaft includes a recessed groove that faces the radially inner end of the second slit and extends in the axial direction.

(5) The rotor according to any one of (1) to (4), in which the second slit includes a plurality of magnet housing portions aligned in the circumferential direction and each housing each of the plurality of auxiliary magnets.

(6) The rotor according to any one of (1) to (5), in which the outer flux barrier portion has a circumferential dimension larger than a radial dimension.

(7) The rotor according to any one of (1) to (6), in which the outer flux barrier portion extends along the circumferential direction in a shape protruding radially inward when viewed from the axial direction.

(8) The rotor according to any one of (1) to (7), in which the auxiliary magnet is a rare earth sintered magnet.

(9) The rotor according to any one of (1) to (8), in which the rotor includes six or more of the slit groups.

(10) The rotor according to any one of (1) to (9), further including a plurality of main magnets disposed in the rotor core, in which each of the plurality of main magnets is disposed in at least one of the plurality of first slits in each of the slit groups, and has a magnetization direction in the radial direction.

(11) The rotor according to any one of (1) to (10), further including a plurality of conductors disposed in the rotor core, in which each of the plurality of conductors is disposed in at least one of the plurality of first slits in each of the slit groups.

(12) A motor including: the rotor according to any one of (1) to (11); and a stator that surrounds the rotor from a radially outer side.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotor rotatable about a central axis as a rotation axis, the rotor comprising:
a rotor core extending along an axial direction; and
a plurality of auxiliary magnets disposed in the rotor core, wherein
the rotor core includes:
a slit group including a plurality of first slits aligned in a radial direction; and
a second slit disposed on a radially inner side of the slit group when viewed from the axial direction,
a plurality of the slit groups and a plurality of the second slits are respectively aligned in a circumferential direction,
each of the plurality of first slits extends along the circumferential direction in a shape protruding radially inward when viewed from the axial direction,
the second slit includes:
a magnet housing portion extending along the radial direction; and
a pair of outer flux barrier portions extending from a radially outer end of the magnet housing portion to one side and another side in the circumferential direction, and
each of the auxiliary magnets is disposed in the magnet housing portion with the circumferential direction as a magnetization direction.

2. The rotor according to claim 1, wherein the second slit includes a pair of inner flux barrier portions extending from a radially inner end of the magnet housing portion to the one side and the other side in the circumferential direction.

3. The rotor according to claim 1, further comprising a shaft extending in the axial direction along the central axis, wherein
the rotor core has a central hole through which the shaft passes,
the second slit is connected to the central hole at a radially inner end, and
at least a part of an outer peripheral surface of the shaft or at least a part of an inner peripheral surface of the central hole is made of a paramagnetic material.

4. The rotor according to claim 1, further comprising a shaft extending in the axial direction with the central axis as a center, wherein
the rotor core has a central hole through which the shaft passes,
the second slit is connected to the central hole at a radially inner end, and
an outer peripheral surface of the shaft includes a recessed groove that faces the radially inner end of the second slit and extends in the axial direction.

5. The rotor according to claim 1, wherein the second slit includes a plurality of magnet housing portions aligned in the circumferential direction and each housing each of the plurality of auxiliary magnets.

6. The rotor according to claim 1, wherein the outer flux barrier portion has a circumferential dimension larger than a radial dimension.

7. The rotor according to claim 2, wherein the outer flux barrier portion has a circumferential dimension larger than a radial dimension.

8. The rotor according to claim 4, wherein the outer flux barrier portion has a circumferential dimension larger than a radial dimension.

9. The rotor according to claim 1, wherein the outer flux barrier portion extends along the circumferential direction in a shape protruding radially inward when viewed from the axial direction.

10. The rotor according to claim 2, wherein the outer flux barrier portion extends along the circumferential direction in a shape protruding radially inward when viewed from the axial direction.

11. The rotor according to claim 1, wherein each of the plurality of auxiliary magnets is a rare earth sintered magnet.

12. The rotor according to claim 1, wherein the rotor includes six or more of the slit groups.

13. The rotor according to claim 1, further comprising a shaft extending in the axial direction with the central axis as a center, wherein
the rotor core has a central hole through which the shaft passes,
the second slit is connected to the central hole at a radially inner end,
an outer peripheral surface of the shaft has a recessed groove that faces a radially inner end of the second slit and extends in the axial direction,
the second slit includes a plurality of magnet housing portions arranged in the circumferential direction and each housing each of the plurality of auxiliary magnets,
the outer flux barrier portion has a circumferential dimension larger than a radial dimension,
the rotor includes six or more of the slit groups, and
the rotor includes a plurality of main magnets disposed in the rotor core.

14. The rotor according to claim 1, further comprising a plurality of conductors disposed in the rotor core, wherein each of the plurality of conductors is disposed in at least one of the plurality of first slits in each of the slit groups.

15. A motor comprising:
the rotor according to claim 1; and
a stator that surrounds the rotor from a radially outer side.

16. A motor comprising:
the rotor according to claim 3; and
a stator that surrounds the rotor from a radially outer side.

17. A motor comprising:
the rotor according to claim 4; and
a stator that surrounds the rotor from a radially outer side.

18. A motor comprising:
the rotor according to claim 1; and
a stator that surrounds the rotor from a radially outer side, wherein
the rotor comprises a shaft extending in the axial direction with the central axis as a center,
the rotor core has a central hole through which the shaft passes,
the second slit is connected to the central hole at a radially inner end,
an outer peripheral surface of the shaft has a recessed groove that faces a radially inner end of the second slit and extends in the axial direction,
the second slit includes a plurality of magnet housing portions arranged in the circumferential direction and each housing each of the plurality of auxiliary magnets,
the outer flux barrier portion has a circumferential dimension larger than a radial dimension,
the rotor includes six or more of the slit groups, and
the rotor includes a plurality of main magnets disposed in the rotor core.
